(19) United States
(12) Patent Application Publication
(10) Pub. No.: US 2013/0266273 A1
(43) Pub. Date: Oct. 10, 2013

(54) APPARATUS FOR TRANSMITTING HIGH SPEED DATA VIA A CABLE

(71) Applicant: SEMTECH CANADA CORPORATION, Burlington (CA)

(72) Inventor: Imran Sherazi, Ottawa (CA)

(73) Assignee: SEMTECH CANADA CORPORATION, Burlington (CA)

(21) Appl. No.: 13/845,418

(22) Filed: Mar. 18, 2013

Related U.S. Application Data
(60) Provisional application No. 61/620,839, filed on Apr. 5, 2012.

(51) Int. Cl. G02B 6/42

(52) U.S. Cl. CPC G02B 6/4293
USPC 385/89

(57) ABSTRACT

An adapter is provided for coupling between a Thunderbolt® compliant connector and a pluggable optical transceiver connector of a pluggable optical transceiver host board, the pluggable optical transceiver connector for connecting with an optical pluggable transceiver and other than a connector compliant with a Thunderbolt® standard. The adapter has a first connector for mating with the pluggable optical transceiver connector and a second connector for coupling with a Thunderbolt compliant connector.

### FIELD OF THE INVENTION

The invention relates to inter-equipment data transmission and more particularly to high-speed data transmission between communication equipment.

### BACKGROUND

Small form factor pluggable optical modules, are used to drive a communication channel between communication equipment. The use of a module is beneficial as it supports easy maintenance and allows for a common communication interface at each end of a cable. Further, it allows for different optical interfaces for different purposes, such as transmission path lengths.

### SUMMARY OF THE INVENTION

In accordance with an embodiment of the invention there is provided an adapter comprising: a first connector for connecting with a pluggable optical transceiver connector of a pluggable optical transceiver host board, the pluggable optical transceiver connector for connecting with an optical pluggable transceiver and other than a connector compliant with a Thunderbolt® standard; and a second connector for connecting with a connector compliant with a Thunderbolt® standard, the first connector and the second connector electrically connected one to the other for providing electrical signals therebetween.

In accordance with another embodiment, there is provided an adapter comprising: a first connector for connecting with an optical pluggable transceiver host board via a pluggable optical transceiver connector and other than a connector compliant with a Thunderbolt® standard, the pluggable optical transceiver connector for connecting with an optical pluggable transceiver; and a second connector for connecting with a cable, the cable for transmission of data corresponding to a first standard other than an optical pluggable transceiver standard, the first connector and the second connector electrically connected one to the other for providing electrical signals therebetween.

In accordance with another embodiment, there is provided a cable assembly comprising: an electrical cable comprising a first connector and a second connector, the electrical cable for transmitting data between the first connector and the second connector, the data transmitted in accordance with a Thunderbolt® standard, the first connector for connecting with a first optical pluggable transceiver host board via a pluggable optical transceiver connector other than a connector according to a Thunderbolt® standard.

In accordance with another embodiment, there is provided a cable assembly comprising: an electrical cable for the transmission of data corresponding to a Thunderbolt® standard between a first connector and a second connector, the first connector for connecting with a first optical pluggable transceiver host board via a pluggable optical transceiver connector, the optical transceiver host board connector comprising circuitry for transmitting and receiving data corresponding to a first standard, the second connector for connecting with a second optical pluggable transceiver host board via a pluggable optical transceiver connector, the optical transceiver host board comprising circuitry for transmitting and receiving data corresponding to the first standard, the first standard other than a Thunderbolt® standard.

In accordance with another embodiment, there is provided an adapter comprising: a first connector for connecting with an interface for being connected to an optical pluggable transceiver and other than a connector compliant with a Thunderbolt® standard; and a second connector for connecting with a connector compliant with a Thunderbolt® standard, the first and second connector electrically connected one to the other for providing electrical signals therebetween.

In accordance with some embodiments, the first connector is one of an SFP, SFP+, QSFP, QSP+, CFP, CXP, and XFP connector.

### BRIEF DESCRIPTION OF THE DRAWINGS

The features and advantages of the invention will become more apparent from the following detailed description of the preferred embodiment(s) with reference to the attached figures, wherein:

FIG. 1 is a simplified diagram of a service provider equipment facility in the form of a data centre;

FIG. 2 is a simplified diagram of an optical coupling between equipment;

FIG. 3 is a simplified diagram of an adapter;

FIG. 4 is a simplified diagram of a coupling between equipment effected using two adapters and a consumer electronic cable;

FIG. 5 is a simplified diagram of a coupling between equipment effected using a custom electronic cable relying on a consumer communication standard and have connectors for coupling with a connector on the equipment;

FIG. 6 is a is a simplified diagram of an adapter cable according to an embodiment;

FIG. 7 is a simplified diagram of an adapter cable according to an embodiment;

FIG. 8a shows a simplified diagram of another cable assembly wherein a single adapter couples with two pluggable optical transceiver connectors; and

FIG. 8b shows a simplified diagram of another cable assembly wherein a single adapter couples with four pluggable optical transceiver connectors.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

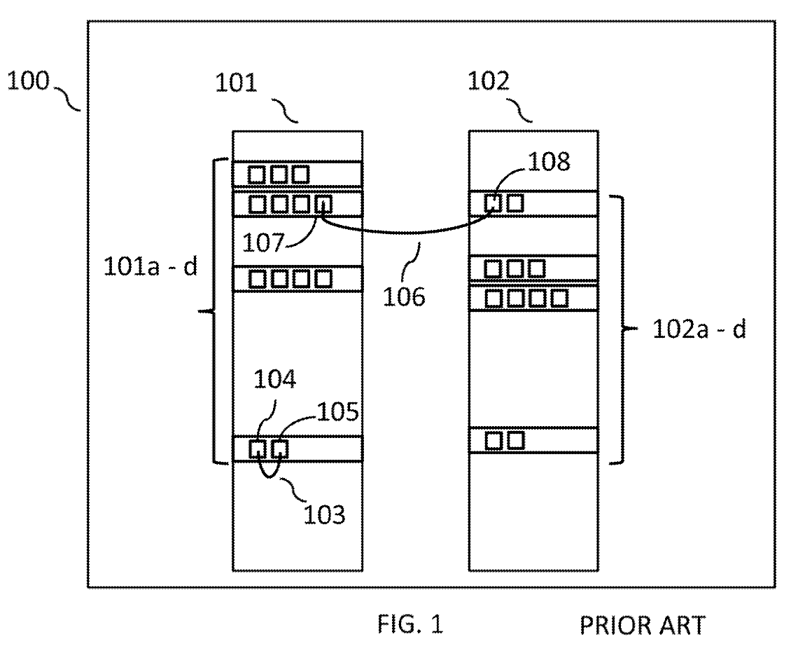

Telecommunication and data communication service providers frequently install large quantities of communication equipment, including line cards, at the same location. To transport/route data through a service provider's communications network, equipment is often interconnected, providing a data path for network traffic. However, once equipment is co-located it is also possible to support inter-equipment data communication via an alternative bus or communication port. Alternatively, a data port on a piece of equipment is interconnected with a different data port on the same piece of equipment. For example, shown in FIG. 1 is a service provider equipment facility in the form of data centre 100, comprising equipment racks 101 and 102 for storing communication equipment 101a-101d and 102a-102d, each piece of equipment comprises data ports, for example, equipment 101d comprises data ports 104 and 105, equipment port 101b comprises data port 107, and equipment 102a comprises data port 108.

For low speed data communication rates, electrical communication cables are used. Electrical communication cables are inexpensive and often available in consumer quantities for low speed communication. However, for high data rates, equipment is designed for optical communication. Optical communication has significant advantages over electrical communication. In particular, optical signals are less affected by electromagnetic interference and cause less electromagnetic interference. As such, optical signals are useful at very high data rates, across greater distances and with greater reliability. Unfortunately, the components used for optical communication are somewhat specialized and have not seen the volume pricing benefit seen by electrical components.

Small form factor standards specify on board connectors for being mated with small form factor pluggable optical transceivers (SFPs) to transmit and receive high speed data between different data ports. An optical transceiver is a laser that transmits and a light receiver that receives light propagating through a fiber optic cable. An SFP is other than permanently fixed to the communication equipment and is designed to be plugged into and removed from a connector of the communication equipment. This allows for easy replacement should an SFP no longer function or should communication requirements change. In this example, data ports 104, 105, 107 and 108 are populated with SFPs. Data port 104 is connected to data port 105 via a fiber optic cable 103 on equipment 101d and data port 107 on equipment 101b is connected with data port 108 on equipment 102a. Easy replacement of SFPs is highly advantageous, however as they are highly specialized devices designed for use in specific communication equipment, the low quantities cause high manufacturing cost.

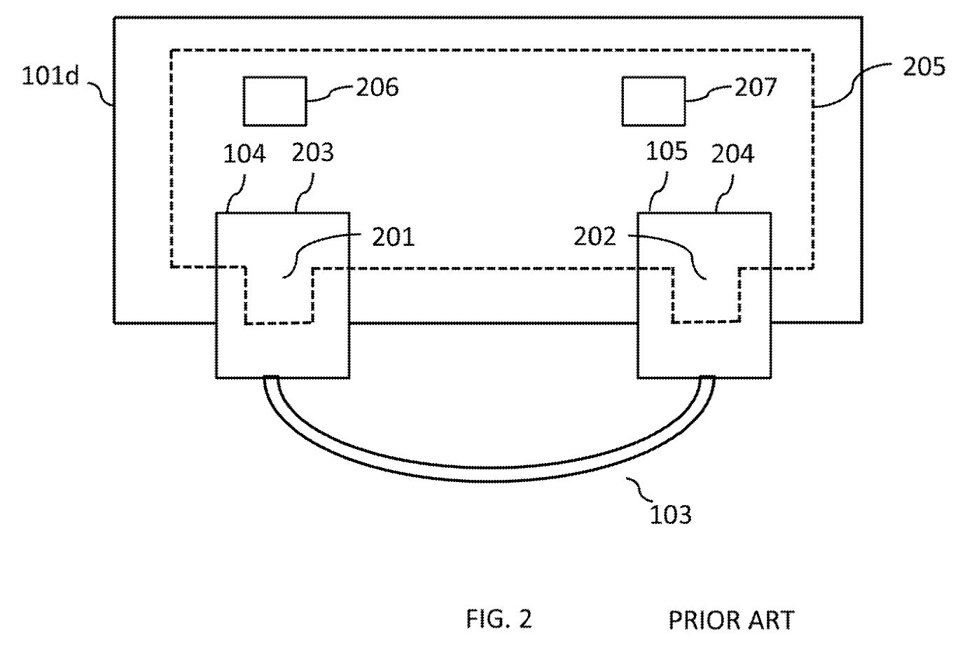

Now referring to FIG. 2, shown is equipment 101d with data ports 104 and 105 populated with pluggable optical transceivers in the form of SFPs, 203 and 204 respectively. SFP 203 is mated to a pluggable optical transceiver connector 201 of a pluggable optical transceiver host board 205 comprising circuitry 206 for interfacing with an SFP, in this example, SFP 203. Circuitry 206 transmits data to and receives data from SFP 203 via connector 201 according to an SFP standard. Data is transmitted from SFP 203 to SFP 204, populated in data port 105, via fiber optic cable 103. SFP 204 is mated with a pluggable optical transceiver connector 202 of pluggable optical transceiver host board 205 and transmits data to and receives data from circuitry 202 via connector 201 according to a pluggable optical transceiver standard.

Also, an SFP is often associated with a communication distance since transmitting light further typically involves a brighter laser and potentially a more sensitive receiver. Thus, several configurations of SFPs are often used in a single location further reducing the volume of each SFP. Unfortunately, the brighter lasers are more costly so they have not become ubiquitous, as of yet.

Unfortunately, wide adoption of SFP standards has not resulted in significant volume based cost savings and, as such, the high bandwidth transceiver remains quite costly. Further, SFPs are required at each end of a communication path, requiring two per connection. It would be advantageous to provide a higher volume solution for the SFP in order to reduce system and maintenance costs.

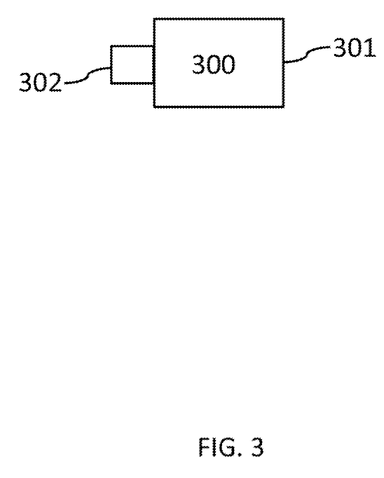

Shown in FIG. 3 is a simplified diagram of an adapter according to an embodiment of the invention. Adapter 300 comprises two connectors, 301 and 302. Connector 301 mates with a pluggable optical transceiver connector of a pluggable optical transceiver host board. Connector 301 is electrically connected to connector 302 wherein electrical signals entering one connector are provided to the other connector. Adapter 300 takes the place of a SFP—pluggable optical transceiver—and provides data transmitted from circuitry on a pluggable optical transceiver host board connector 301, according to a pluggable optical transceiver standard. Connector 302 mates with a connector for coupling to a consumer electrical cable in the form of a Thunderbolt® connector. Thus, two low volume optical transceivers are replaced by two passive connectors and a consumer cable having significant volume. Thus, cost reduction is achieved as is improved maintenance—the passive connector is unlikely to fail—and improved availability—an IT professional could go to the local computer store to get a replacement cable.

Of course, the passive module need not be replaced to support longer transmission paths or different SFP modules as a Thunderbolt® cable will terminate communication at both ends and thus, a different consumer volume cable is sometimes used, but the small form factor board and the passive adapter need not be affected. Alternatively, the adapter is other than passive. Even when the adapter is active it is readily apparent from the description herein that the module is cost effective and that optionally a single variant of the module is used to support a wide range of path lengths.

Shifting changes and maintenance issues to a process of changing cables is advantageous as it does not require access and modification to the electronic components and equipment directly and instead operates through ports that are intended to support interfacing with cables and changing of the cable interface at relatively frequent intervals as opposed to simply at maintenance intervals.

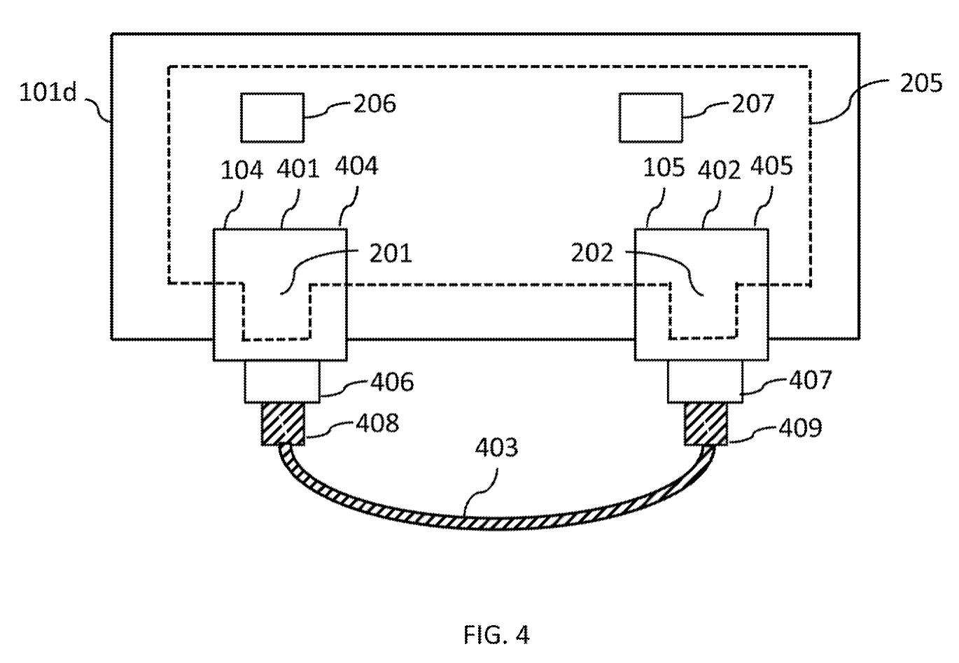

FIG. 4 is a simplified diagram of adapters populating data ports on communication equipment. Adapter 401 comprises two connectors 404 and 406 and is inserted into communication equipment 101d wherein connector 404 mates with a pluggable optical transceiver connector 201 of a pluggable optical transceiver host board 205. Connector 406 mates with a connector of a cable for transmitting data according to a first standard, the first standard other than a pluggable optical standard. For example, connector 406 mates with Thunderbolt® connector 408 of Thunderbolt® cable 403. Data is transmitted from circuitry 206 to adapter 404 via pluggable optical transceiver host board connector 201. Connector 201 is compliant with a pluggable optical transceiver standard and is for mating to an SFP. Connector 404 is electrically connected to connector 406 wherein electrical signals applied at connector 404 are provided to connector 406, and further provided to Thunderbolt® cable 403 via Thunderbolt® connector 408.

The data provided to Thunderbolt® connector 409 at the far end of Thunderbolt® cable 403 was transmitted via cable 403 in accordance with a Thunderbolt® standard. The received data is transmitted from the Thunderbolt® connector 409 to circuitry 207 by means of adapter 402. Thunderbolt® connector 409 mates to connector 407 of adapter 402 which is electrically connected to connector 405 wherein electrical signals applied at connector 407 is provided to connector 405, and further provided to circuitry 207. In this example, Thunderbolt® cables are significantly cheaper than SFPs and an optical cable as the SFPs are highly specialized devices designed for use in communication equipment whereas Thunderbolt® cables are widely used for a variety of applications and thus are manufactured in larger quantities.

Alternatively, the first standard is other than a Thunderbolt® standard. The adapter board can connect to various existing and future electrical cables with any necessary circuitry thereon. Less circuitry or less costly components within the adapter board is advantageous because the adapter board is a specialized device, whereas the active Thunderbolt® cable or another active cable is distributed in larger quantities for varied applications.

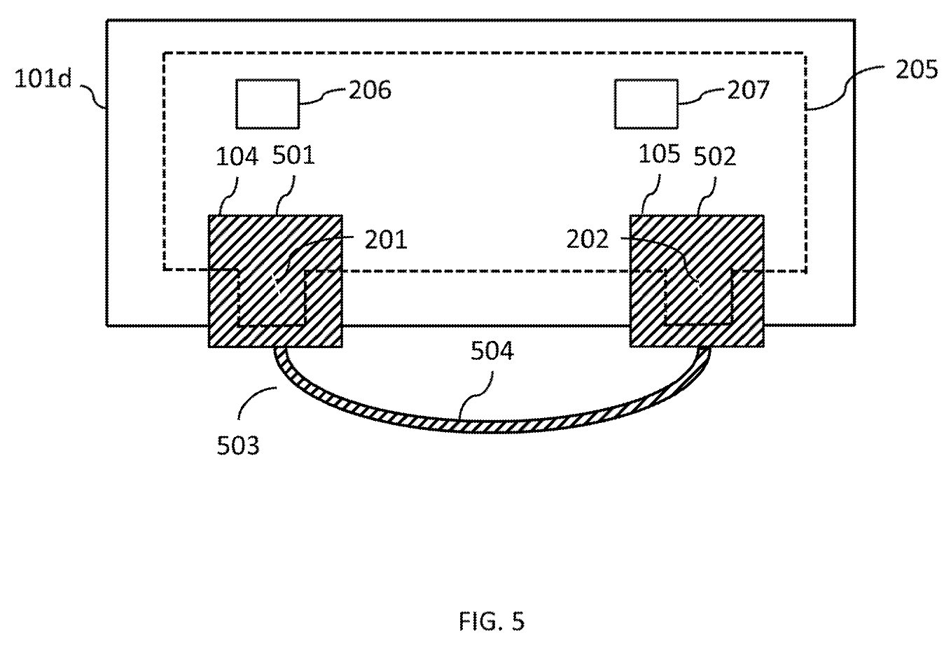

Referring now to FIG. 5, shown is a cable assembly according to an embodiment of the invention. Cable assembly 503 comprises connectors 501 and 502 and electrical cable 504 for the transmission of data between the two connectors. Connectors 501 and 502 mate with pluggable optical transceiver connectors 201 and 202, respectively, of pluggable optical transceiver host board 205 and are other than standard Thunderbolt® connectors. Circuitry inside connector 501 transmits received data from circuitry 206 to connector 502 corresponding to a second standard other than a pluggable optical transceiver standard, for example, a Thunderbolt® standard. For example, each connector is coupled to Thunderbolt® compliant circuitry for supporting the electrical signal communication. Alternatively, the second standard is other than a Thunderbolt® standard.

Though the embodiment of FIG. 5 does not benefit from the consumer quantities for the consumer cable, it still benefits from consumer volumes of the electronic circuitry used within the cable and, as such, remains more cost effective than specialized hardware.

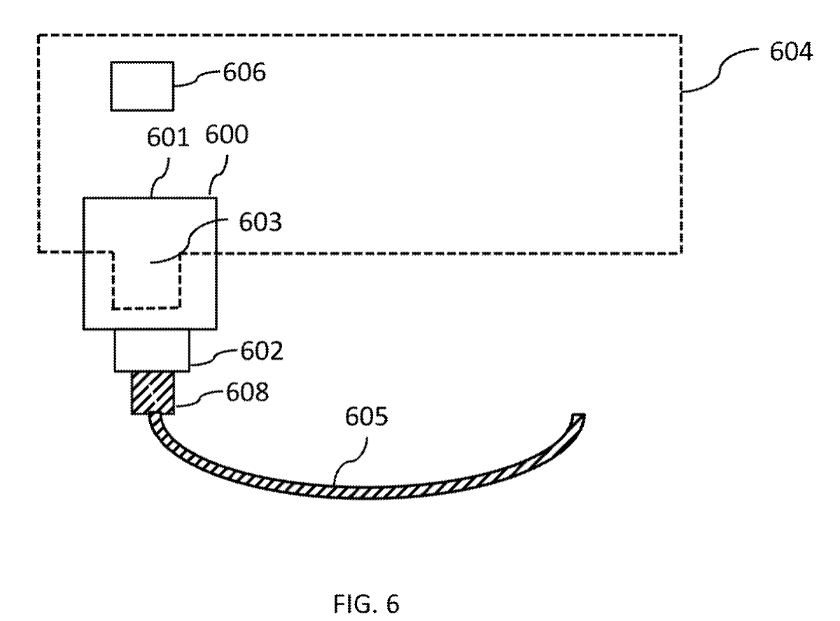

Shown in FIG. 6 is a simplified diagram of an adapter according to an embodiment of the invention. Connector 600 comprises two connectors, 601 and 602. Connector 601 mates with a pluggable optical transceiver connector of a pluggable optical transceiver host board 603. Connector 601 is electrically connected to connector 602 wherein electrical signals entering one connector are provided to the other connector. Connector 600 takes the place of an SFP populated in a data port and provides data transmitted from circuitry 606 on a pluggable transceiver host board and connector 603, to connector 601 according to a pluggable optical transceiver standard. Connector 602 mates with a connector 608 other than an pluggable optical transceiver connector. A standard consumer digital high speed electronic transmission cable 605 is coupled to connector 608 for actively propagating a signal provided thereto to an opposing end thereof.

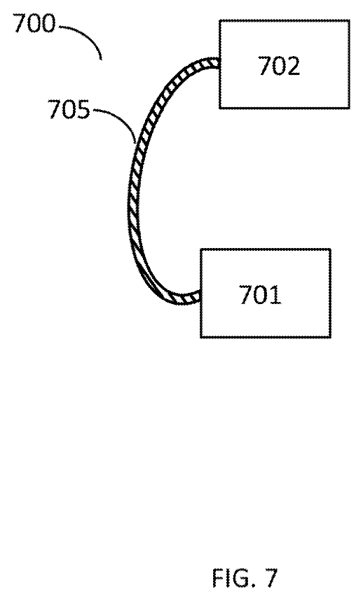

Shown in FIG. 7 is a simplified diagram of an adapter cable according to an embodiment of the invention. Adapter cable 700 comprises two connectors, 701 and 702. Connector 701 mates with a pluggable optical transceiver connector of a pluggable optical transceiver host board. Connector 701 is electrically connected to connector 702 wherein electrical signals entering one connector are provided to the other connector via active cable 705. Adapter cable 700 takes the place of a pluggable optical transceiver populated in a data port, for example an SFP, and a cable coupled thereto. The cable provides data transmitted from circuitry on a pluggable transceiver host board connector, according to a pluggable optical transceiver standard via the active cable to connector 701. Connector 702 mates with a connector other than a pluggable optical transceiver connector, for example a Thunderbolt® connector. For example, the adaptor of FIG. 3 is connected to connector 702 and to a small form factor board.

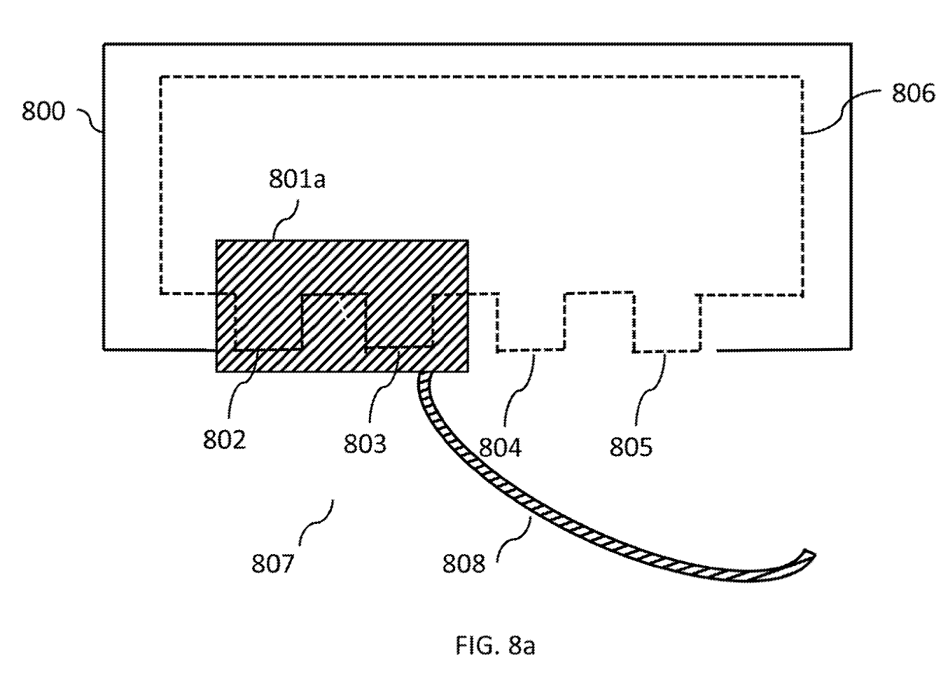

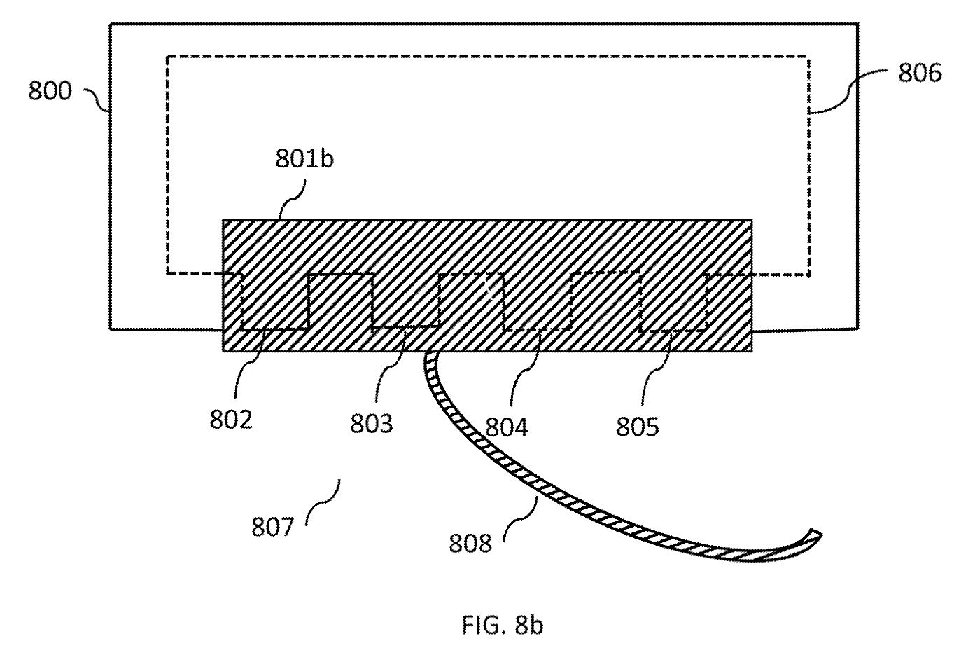

Referring now to FIG. 8a, shown is a cable assembly according to an embodiment of the invention. Cable assembly 807 comprises connector 801a, which mates to two pluggable optical transceiver connectors 802 and 803, of pluggable optical transceiver host board 806 and electrical cable 808 for the transmission of data between connector 801a and a connector at the other end of cable 808. Connector 801a is other than a standard Thunderbolt® connector. Circuitry inside connector 801a transmits received data from pluggable optical transceiver connectors 802 and 803 to connector 801a corresponding to a second standard other than a pluggable optical transceiver standard, for example, a Thunderbolt® standard. For example, each connector, 802 and 803, is coupled to Thunderbolt® compliant circuitry for supporting the electrical signal communication. Alternatively, the second standard is other than a Thunderbolt® standard.

Referring now to FIG. 8b, shown is a cable assembly according to an embodiment of the invention. Cable assembly 807 comprises connector 801b, which mates to four pluggable optical transceiver connectors 802, 803, 804, and 805, of pluggable optical transceiver host board 806 and electrical cable 808 for the transmission of data between connector 801b and a connector at the other end of cable 808. Connector 801b is other than a standard Thunderbolt® connector. Circuitry inside connector 801b transmits received data from pluggable optical transceiver connectors 802, 803, 804, and 805 to connector 801b corresponding to a second standard other than a pluggable optical transceiver standard, for example, a Thunderbolt® standard. For example, each connector, 802, 803, 804, and 805, is coupled to Thunderbolt® compliant circuitry for supporting the electrical signal communication. Alternatively, the second standard is other than a Thunderbolt® standard.

Alternatively, the embodiments of FIGS. 8a and 8b are implemented as adapters with a connector, for example a Thunderbolt® compliant connector, for coupling with an active cable.

Although the term SFP is used through out this description, one skilled in the art would be aware that an SFP could be replaced by a small form factor pluggable optical transceiver. Some examples include SFP+, QSFP, QSP+, CFP, CXP, and XFP.

Numerous other embodiments may be envisaged without departing from the scope of the invention.

What is claimed is:

1. An adapter comprising:
a first connector for connecting with a pluggable optical transceiver connector of a pluggable optical transceiver host board, the pluggable optical transceiver connector for connecting with an optical pluggable transceiver and the first connector other than a connector compliant with a Thunderbolt® standard; and
a second connector for connecting with a connector compliant with a Thunderbolt® standard, the first connector and the second connector electrically connected one to the other for providing electrical signals therebetween.

2. The adapter as defined in claim 1 wherein the first connector comprises an SFP connector.

3. The adapter as defined in claim 1 wherein the first connector comprises an SFP+connector.

4. The adapter as defined in claim 1 wherein the first connector comprises a QSFP+connector.

5. The adapter as defined in claim 1 wherein the first connector comprises a CXP connector.

6. The adapter as defined in claim 1 wherein the first connector comprises a CFP connector.

7. The adapter as defined in claim 1 wherein the first connector comprises an XFP connector.

8. The adapter as defined in claim 1 wherein the second connector is for interfacing with a Thunderbolt® communication cable according to a Thunderbolt® communication standard.

9. The adapter as defined in claim 1 wherein the adapter is absent active electronic circuitry electrically coupled between the first connector and the second connector.

10. The adapter as defined in claim 1 further comprising traces coupling the first connector and the second connector one to another.

11. The adapter as defined in claim 1 further comprising traces coupling the first connector to the second connector and at least one of a resistor, a capacitor, and a diode.

12. An adapter comprising:
a first connector for connecting with an pluggable optical transceiver host board via a pluggable optical transceiver connector and the first connector other than a connector compliant with a Thunderbolt® standard, the pluggable optical transceiver connector for connecting with an optical pluggable transceiver; and
a second connector for connecting with a cable, the cable for transmission of data corresponding to a first standard other than an optical pluggable transceiver standard, the first connector and the second connector electrically connected one to the other for providing electrical signals therebetween.

13. The adapter as defined in claim 12 wherein the first connector comprises an SFP connector.

14. The adapter as defined in claim 12 wherein the first connector comprises an SFP+ connector.

15. The adapter as defined in claim 12 wherein the first connector comprises a QSFP+ connector.

16. The adapter as defined in claim 12 wherein the first connector comprises a CXP connector.

17. The adapter as defined in claim 12 wherein the first connector comprises a CFP connector.

18. The adapter as defined in claim 12 wherein the first connector comprises an XFP connector.

19. The adapter as defined in claim 12 wherein the second connector is for interfacing with a Thunderbolt® communication cable according to a Thunderbolt® communication standard.

20. The adapter as defined in claim 12 wherein the adapter is absent active electronic circuitry electrically coupled between the first connector and the second connector.

21. The adapter as defined in claim 12 further comprising traces coupling the first adapter and the second adapter one to another.

22. The adapter as defined in claim 12 further comprising traces coupling the first connector and the second connector one to the other and at least one of a resistor, a capacitor, and a diode.

23. A cable assembly comprising:
a first connector and a second connector; and
an electrical cable for transmitting data between the first connector and the second connector, the data transmitted in accordance with a Thunderbolt® standard, the first connector for connecting with a first pluggable optical transceiver host board via a pluggable optical transceiver connector other than a connector according to a Thunderbolt® standard.

24. The cable assembly as defined in claim 23 wherein the second connector is for connecting with a second pluggable optical transceiver host board via a pluggable optical transceiver connector other than a connector according to a Thunderbolt® standard.

25. The cable assembly as defined in claim 23 wherein the first connector is an SFP connector.

26. The cable assembly as defined in claim 23 wherein the first connector is an SFP+ connector.

27. The cable assembly as defined in claim 23 wherein the first connector is a QSFP connector.

28. The cable assembly as defined in claim 23 wherein the first connector is a QSFP connector.

29. The cable assembly as defined in claim 23 wherein the first connector is a CXP connector.

30. The cable assembly as defined in claim 23 wherein the first connector is a CFP connector.

31. The cable assembly as defined in claim 23 wherein the first connector is a XFP connector.

32. The cable assembly as defined in claim 24 wherein the first pluggable optical transceiver host board and second pluggable optical transceiver host board each comprises first circuitry for transmitting and receiving data via the electrical cable in accordance with a Thunderbolt® standard.

33. The cable assembly as defined in claim 23 wherein the second connector is a connector according to a Thunderbolt® standard.

34. The cable assembly as defined in claim 23 wherein the second connector is a connector other than a connector for connecting with a first pluggable optical transceiver host board via a pluggable optical transceiver connector.

35. A cable assembly comprising:
a first connector and a second connector;
an electrical cable for the transmission of data corresponding to a Thunderbolt® standard between the first connector and the second connector,
the first connector for connecting with a first pluggable optical transceiver host board via a pluggable optical transceiver connector, the first pluggable optical transceiver host board comprising circuitry for transmitting and receiving data corresponding to a first standard, the second connector for connecting with a second pluggable optical transceiver host board via a pluggable optical transceiver connector, the second pluggable optical transceiver host board comprising circuitry for transmitting and receiving data corresponding to the first standard, the first standard other than a Thunderbolt® standard.

36. The cable assembly as defined in claim 35 wherein the first connector is an SFP connector.

37. The cable assembly as defined in claim 35 wherein the first connector is an SFP+ connector.

38. The cable assembly as defined in claim 35 wherein the first connector is a QSFP connector.

39. The cable assembly as defined in claim 35 wherein the first connector is a QSFP connector.

40. The cable assembly as defined in claim 35 wherein the first connector is a CXP connector.

41. The cable assembly as defined in claim 35 wherein the first connector is a CFP connector.

42. The cable assembly as defined in claim 35 wherein the first connector is an XFP connector.

43. An adapter comprising:
a first connector for connecting with an interface for being connected to an optical pluggable transceiver and other than a connector compliant with a Thunderbolt® standard; and
a second connector for connecting with a connector compliant with a Thunderbolt® standard, the first and second connector electrically connected one to the other for providing electrical signals therebetween.

44. The adapter as defined in claim 43 wherein circuitry within the adapter is for coupling with an active electronic cable and other than for coupling with a passive electronic cable for inter equipment data communication

45. A line card for communication equipment comprising:
a connector for being coupled with an active electrical cable, the connector for use in accordance with a standard, the standard for an active electrical data transmission cable and other than a pluggable optical transceiver connector.

46. The line card as defined in claim 45 wherein the standard comprises a Thunderbolt® standard.

47. The line card as defined in claim 45 comprising:
a pluggable optical transceiver connector.

48. An adapter as defined in claim 1 comprising an optical transceiver.
